(19) United States
(12) Patent Application Publication
(10) Pub. No.: US 2007/0140222 A1
(43) Pub. Date: Jun. 21, 2007

(54) Facilitating the exchange of a position on a waiting list

(76) Inventor: Matthew Kowalczyk, Seattle, WA (US)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(21) Appl. No.: 11/313,866

(22) Filed: Dec. 20, 2005

(51) Int. Cl. H04L 12/66

(52) U.S. Cl. 370/352

(57) ABSTRACT

The present invention provides a method, computer-readable medium and software system for allowing computer users to exchange a position on a waiting list. In accordance with one embodiment, a method is provided that facilitates the exchange of one or more positions on a waiting list using networked computers. In this embodiment, the method includes building a waiting list that has an order of priority to a good or service. Once a waiting list exists, positions on the waiting list may be presented as being available for exchange at a location that is accessible in the networking environment. Then, if an agreement is reached between users to exchange a position on the waiting list, the method facilitates performance of the agreement.

### FIELD OF THE INVENTION

In general, the present invention relates to computer software that executes in a networking environment and, in particular, to a system and method for facilitating the exchange of a position in a waiting list using networked computers.

### BACKGROUND OF THE INVENTION

Computer networks are well known for providing communication between different computing systems to enable one system to share information with another system. For example, a computer system may store information in Web pages or other resources including, but not limited to, documents, files, databases, etc., that are stored or generated dynamically on local or remote computing systems. In this regard, Web pages are often accessed in reference to a Uniform Resource Identifier (“URI”), such as by entering a Uniform Resource Locator into a Web browser. Moreover, Web pages may also be accessed by sending a File Transfer Protocol (“FTP”) command, or otherwise invoking a computer process to obtain access to a Web page. In circumstances where a computer network is involved, a client system may access Web pages using a network address that identifies the desired Web page in the computer network. Moreover, computer networks range from local area networks to wide area networks to global networks including the World Wide Web (sometimes referred to as the “Web” or the “Internet”). The Internet, in particular, enables users to access a large number of Web pages and other network-accessible resources.

In the realm of the Internet, typical computer users access Web pages by instructing a browser program that executes on a local client computer to transmit a request for a Web page using a URL to identify a network domain. Domain name servers direct the Web page request to one or more server computers that correspond to the network domain identified in the URL. When a server computer receive a Web page request, the server computer transmits markup code that embodies the Web page to the client computer of the requesting user. The user's browser program receives the markup code and displays the Web page to the user which, typically, includes various hyperlinks that point to or link other network addresses of other Web pages.

The sharing of information between computer systems using the techniques described briefly above is an increasingly popular way of conducting business. In fact, the explosive growth of the Internet is generating changes in classic business and economic models. For example, using network-accessible computer systems, potential customers are able to identify and purchase a wide variety of goods and services over computer networks from Internet marketplaces, shopping sites, auction houses, and the like that was not previously possible. In this regard, the potential customer base of these online retailers has greatly expanded because geographic limitations are less relevant when conducting business over a computer network. Instead, customers may be located vast distances away from an online retailer that is providing the good or service.

To a large degree, the success of an online retailer or a retailer that merely established a presence on a computer network, depends on the retailer's ability to provide an enjoyable experience and an easy-to-use environment in which customers may efficiently conduct business. In this regard, online retailers frequently have services that are not easily provided in a “brick and mortar” retail outlet. For example, some online retailers provide a forum for users to rate products. By way of another example, online retailers frequently provide recommendations to potential customers based on their observable Web browsing and purchasing habits. In any event, the popularity of an retailer is based, at least partially on, the ability of the retailer to provide services to potential customers that make purchasing convenient and enjoyable.

Frequently, products or services that are offered online by a retailer requires potential customers to wait until a product or service becomes available. In this regard, a retailer may establish a waiting list of potential customers that want to purchase the product or service. More generally, waiting lists are typically established whenever a product or service is in limited supply and a shortage exists. Customers that “sign-up” on a waiting list obtain the product or service based on the ordering of the waiting list. Stated differently, first-in-time potential customers have priority over other potential customers that sign-up on the waiting list at a later point in time. In some instances, potential customer with low priority may never be able to obtain the product or service or only have priority at a time that is undesirable. Moreover, in these types of systems, a potential customer may not be able to easily purchase or otherwise exchange a position on the waiting list from another potential customer. For example, a potential customer that has a high priority on the waiting list may be willing to sell their position for a specified return of value. Conversely, another potential customer may have low priority position and be willing to purchase a higher priority position. In existing systems, it may be difficult or impossible for a potential customer with a high priority position on a waiting list to sell or otherwise exchange their position with another potential customer.

In light of the above-identified problems, it would be beneficial to computer users, both in terms of convenience and efficiency, to have a software system that facilitates the exchange of the position on a waiting list. Preferably, the software system may be used over existing computer networks that are capable of transmitting data between users who may be remotely located.

### SUMMARY OF THE INVENTION

Generally described, embodiments of the present invention are directed at allowing computer users to exchange a position on a waiting list. In accordance with one embodiment, a method is provided that facilitates the exchange of one or more positions on a waiting list using networked computers. In this embodiment, the method includes building a waiting list that has an order of priority to a good or service. Once a waiting list exists, positions on the waiting list may be presented as being available for exchange at a location that is accessible in the networking environment. Then, if an agreement is reached between users to exchange a position on the waiting list, the method facilitates performance of the agreement entered into between the users.

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

### BRIEF DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is an exemplary pictorial depiction of a networking environment that includes a retail server, positioning server, and a plurality of client computers that may be used to describe aspects of the present invention;

FIG. 2 is an exemplary pictorial depiction of a computer architecture for the positioning server depicted in FIG. 1 suitable to facilitate the exchange of positions on the waiting list;

FIGS. 3A and 3B are exemplary flow diagrams of a routine that facilitates the exchange of a position on a waiting list;

FIG. 4 is an exemplary pictorial depiction of a Web page suitable to illustrate one embodiment of the present invention in which a user's positions on a waiting list are presented;

FIG. 5 is an exemplary pictorial depiction of a Web page suitable to illustrate how the present invention may present a marketplace for exchanging positions on a waiting list;

FIG. 6 is an exemplary pictorial depiction of a Web page suitable to illustrate another embodiment for presenting and obtaining data users of the purpose of exchanging positions on a waiting last; and

FIG. 7 is an exemplary pictorial depiction of the retail server and the position server also depicted in FIG. 1 that are suitable to illustrate how waiting list management functions may be provided as a Web service.

### DETAILED DESCRIPTION

Aspects of the present invention may be described in the general context of computer-executable instructions, such as program modules, being executed by a computer. Generally described, program modules include routines, programs, applications, widgets, objects, components, data structures, and the like that perform particular tasks or implement particular abstract data types. Moreover, the present invention will typically be implemented in distributed computing environments where tasks are performed by remote processing devices that are linked through a communications network. In a distributed computing environment, program modules may be located on local and/or remote computer storage media.

The following detailed description provides exemplary implementations of the present invention. Although specific system configurations and flow diagrams are illustrated, it should be understood that the examples provided herein are not exhaustive and do not limit the invention to the precise forms disclosed. Persons having ordinary skill in the field of computers will recognize that components and process steps described herein may be interchangeable with other components or steps, or combinations of components or steps, and still achieve the benefits and advantages of the present invention. It should also be understood that the following description is presented largely in terms of logic and operations that may be performed by conventional computer components. These computer components, which may be grouped in a single location or distributed over a wide area, generally include computer processors, memory storage devices, display devices, input devices, etc. In circumstances where the computer components are distributed, the computer components are accessible to each other via network-accessible communication links.

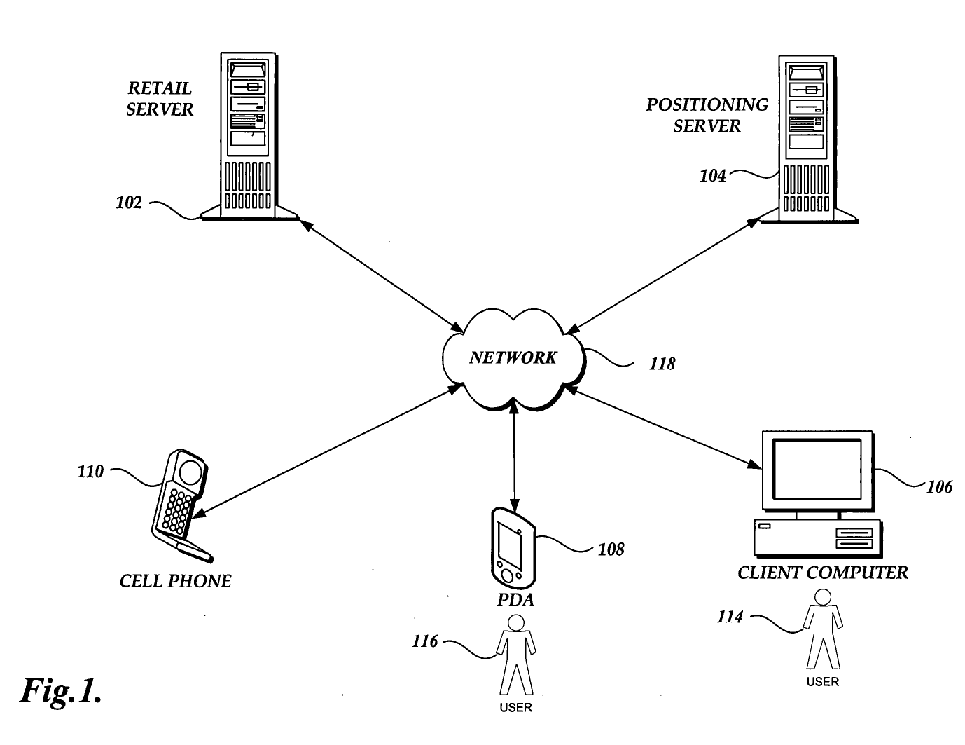

Now with reference to FIG. 1 a brief, general description of a networking environment 100 suitable to implement aspects of the present invention will be described. As illustrated in FIG. 1, the networking environment 100 is comprised of a plurality of computers, namely, the retail server 102, the positioning server 104, the client computer 106, the personal digital assistant (“PDA”) 108, and the cell phone 110. Moreover, the client computer 106 and the PDA 108 are shown associated with the users 114 and 116, respectively. In any event, the retail server 102 and the positioning server 104 are configured to communicate with each other and with the client computer 106, the PDA 108, and the cell phone 110, via the network 118, which may be implemented as a Local Area Network (“LAN”), Wide Area Network (“WAN”), or the global network commonly known as the Internet. As known to those skilled in the art and others, the computers 102, 104, 106, 108, and 110 illustrated in FIG. 1 may be configured to exchange files, commands, and other types of data over the network 118. However, since protocols for network communication such as TCP/IP are well known to those skilled in the art of computer networks, those protocols will not be described here.

For the sake of convenience, FIG. 1 illustrates server computers, a client computer, a PDA, and a cell phone that are usable in the networking environment 100 in which complementary tasks may be performed by remote computers linked together through the communication network 118. However, those skilled in the art will appreciate that aspects of the present invention may be practiced with many other computer system configurations. For example, the present invention may be practiced with a personal computer operating in a stand-alone environment or with multiprocessor systems, minicomputers, mainframe computers, and the like. In this regard, the functions performed by the computers described herein, may be implemented by a plurality of computers. For example, while the positioning server 104 is illustrated as a single computer, server-based functionality is frequently handled in a “server farm” in which multiple servers cooperate in executing necessary tasks so that requests from potentially large numbers of users may be satisfied. Moreover, in addition to the conventional computer systems illustrated in FIG. 1, those skilled in the art and others will also recognize that the present invention may be practiced on other kinds of computers, including laptop computers, tablet computers, or any device on which computer software or other digital content may be executed.

When software that performs the functions of the present invention is implemented in a networking environment, such as the networking environment 100 illustrated in FIG. 1, the software provides a way for users of networked computers to exchange positions in a waiting list. In accordance with one embodiment, any organization that uses a waiting list to prioritize access to a good, service, or any other item of value may have the waiting list managed by software that implements the present invention. Moreover, the software that implements the present invention may be conveniently used in conjunction with existing network configurations and e-commerce Web sites to manage one or more waiting lists and facilitate the exchange of positions on the waiting lists.

In the context of FIG. 1, an organization associated with the retail server 102 provides an e-commerce Web site accessible to the client computers 106, 108, and 110 that places tickets to events (e.g., concerts, sporting events, and the like) for sale to users of the network 118. Consumers are all-too-familiar with the fact that, in some instances, waiting lists are established because of excess demand for a specific event. Moreover, with existing systems, selling or otherwise exchanging a position on a waiting list with another user may not be readily performed. In this regard, as used herein, the term “waiting list” may be implemented using any mechanism that is capable of establishing a priority to a good or service between users. In some instances, a waiting list is implemented internally by the present invention as a data structure that is stored in a database. However, those skilled in the art and others will recognize that other mechanisms exist for implementing a waiting list and the specific examples described herein should be constructed as exemplary and not limiting.

Any organization that employs a waiting list to establish priority to a good or service may have the waiting list managed by aspects of the present invention. In the example mentioned above that involves an e-commerce Web site, a waiting list that defines a priority to a good or service available from the Web site may be managed by software installed on the positioning server 104. In this regard, the retail server 102 may be configured to direct a user to the positioning server 104 when tasks that relate to the waiting list will be performed. Generally described, the positioning server 104 is responsible for managing all aspects of a waiting list on behalf of the organization associated with the retail server 102. For example, the positioning server 104 may be configured to provide a Web site or other type of network-accessible location that provides a user with mechanisms for obtaining positions in a waiting list. Moreover, by navigating to one or more Web pages available from the positioning server 104, a user may view information that describes attributes of the waiting list including, but not limited to, the user's current positions, positions of other users that are offered for sale, and current bids from other users to purchase a position owned by the current user. In this regard, mechanisms are provided so that users may make and accept offers to purchase or sell a position with another user. When an agreement is reached to exchange a position on the waiting list, aspects of the present invention facilitate the exchange by performing any necessary tasks, including updating the internal representation of the waiting list that is used to track which users own a position in the waiting list.

As will be appreciated by those skilled in the art and others, FIG. 1 provides a simplified example of one networking environment 100 suitable for implementing aspects of the present invention. In other embodiments, the functions and features of the computing systems shown (e.g., the retail server 102, the positioning server 104, the client computer 106, the PDA 108, and the cell phone 110) may be implemented using a greater number of computing systems or reduced to a single computing system.

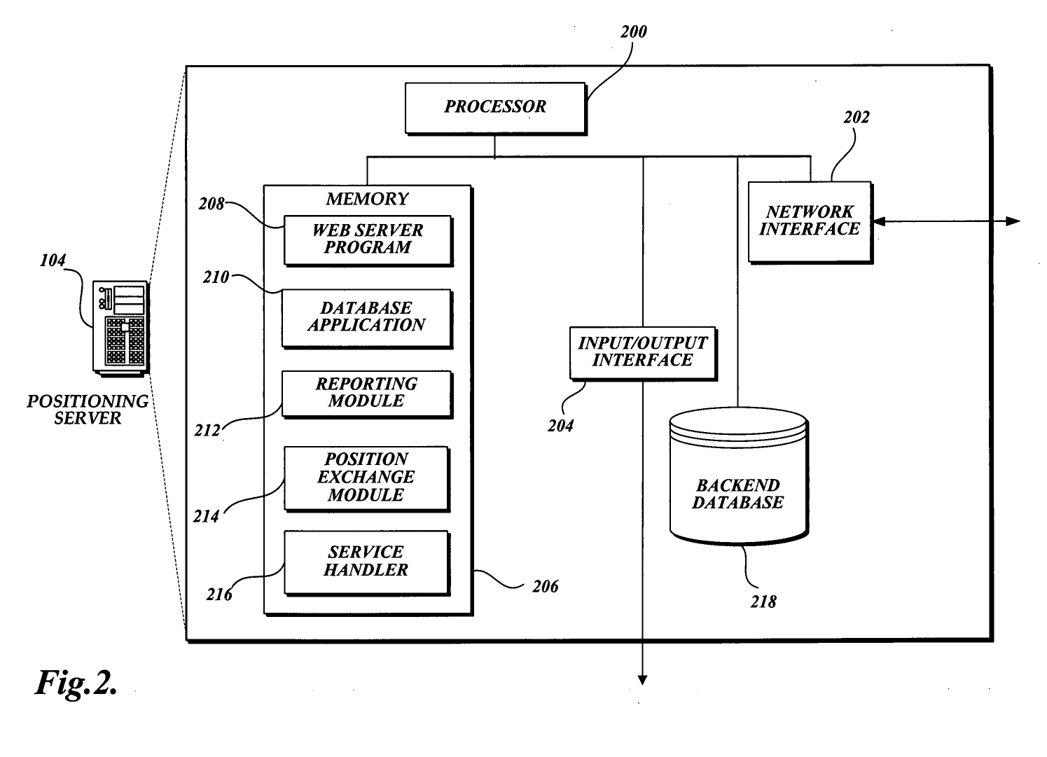

Now with reference to FIG. 2, an exemplary architecture of the positioning server 104 depicted in FIG. 1 that illustrates computer components suitable to implement aspects of the present invention will be described. Those skilled in the art and others will recognize that the positioning server 104 illustrated in FIG. 2 may be any one of a variety of devices including, but not limited to, personal computing devices, server-based computing devices, mini- and mainframe computers, laptops, or other electronic device having some type of memory. In the embodiment of the positioning server 104 illustrated in FIG. 2, the positioning server 104 includes a processor 200 in communication with a variety of computing elements, including a network interface 202, an input/output interface 204, and a memory 206.

The network interface 202 depicted in FIG. 2 enables the positioning server 104 to communicate data, control signals, requests, and other information via a communication network (LAN, WAN, Internet, etc.) such as the network 118 described above with respect to FIG. 1. For instance, the positioning server 104 may receive requests from other networked computers and transmit data back to a requesting computer using the network interface 202.

The input/output interface 204 enables the positioning server 104 to communicate with various local input and output devices. An input device in communication with the input/output interface 204 may include computing elements that provide input signals to the positioning server 104, such as a keyboard, mouse, external memory, disk drive, etc. Also, an output device in communication with the input/output interface 204 may include computing elements that accept output signals such as a monitor, a printer, and the like.

The processor 200 is configured to operate in accordance with computer program instructions stored in a memory, such as the memory 206. In some computing systems, program instructions may also be embodied in a hardware format, such as a programmed digital signal processor. In any event, as illustrated in FIG. 2, the memory 206 stores a Web server program 208, a database application 210, a reporting module 212, a position exchange routine 214, and a service handler 216.

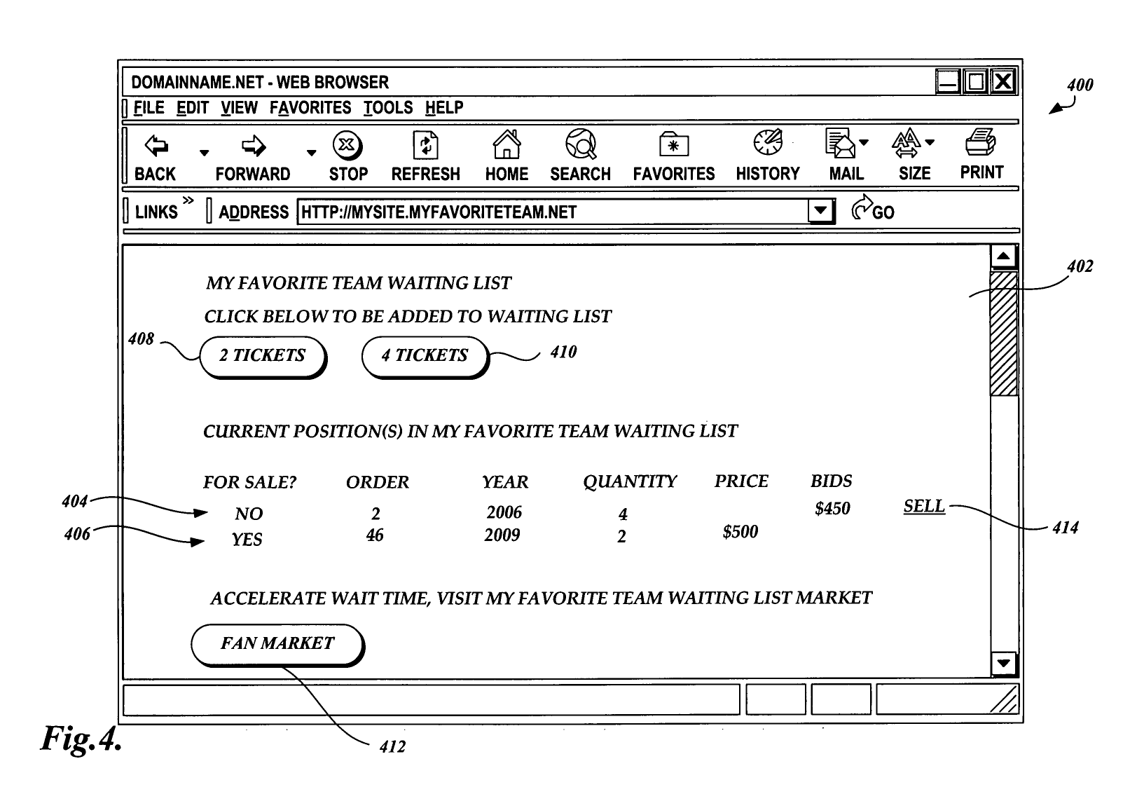

The Web server 208 illustrated in FIG. 2 comprises computer-executable instructions that, when executed by the processor 200, generates configurable markup documents (hereinafter referred to as “Web pages”), such as the sample Web pages depicted in FIGS. 4-6, that are described in more detail below. On one hand, the Web server program 208 provides a way for the positioning server 104 to interact with users of other network-accessible computers. For example, the Web server program 208 is configured to generate Web pages and cause markup code from Web pages to be accessible from the network 118. When a Web page is accessed, the Web server program 208 may receive data back from a networked computer that describes the user's interactions with the Web page. In accordance with one embodiment of the present invention, the content of the Web pages generated by the Web server program 208 serve as an interface that enables users to exchange positions on a waiting list.

On the other hand, the Web server program 208 interacts with other computer components illustrated in FIG. 2 so that the appropriate data may be obtained from or communicated to a user. For example, a request that affects the composition of a waiting list, such as a request to obtain a position on a waiting list, may be obtained from a user. In this instance, data associated with the request is received at the Web server 208 and forwarded to the database application 210 so that the backend database 218 may be updated. As described in further detail below, the backend database 218 is responsible for storing data that includes, but is not limited to, the composition of one or more waiting lists. In this regard, the database application 210 provides mechanisms for updating and/or retrieving data stored in the backend database 218.

As illustrated in FIG. 2, the positioning server 104 includes a database application 210 and a backend database 218. In accordance with aspects of the present invention, the backend database 218 stores the data necessary to provide an online marketplace that enables users to exchange positions in a waiting list. For example, among other things, the backend database 218 stores data that describes transactions that occur in the online marketplace and the composition of one or more waiting lists. However, more generally, the backend database 218 is configured to store all types of different data that are helpful in providing the marketplace, such as demographic information (age, geographic location, consumer preferences, and the like) of users encountered in the online marketplace.

As mentioned previously, the database application 210 provides mechanisms so that components of the positioning server 104 may update or retrieve data that is stored in the backend database 218. For example, when the Web server program 208 generates a Web page, data that describes the composition of a waiting list may need to be presented on the Web page. In order to obtain the appropriate data, a request for data that describes the composition of a waiting list may be issued from the Web server program 208 to the database application 210. In response, the database application 210 causes the requested data to be retrieved from the backend database 218 and passed to the Web server program 208 so that an appropriate Web page may be generated. Generally described, the database application 210 provides functions so data in the backend database 218 may be updated and retrieved, including, but not limited to functions for, adding, deleting, moving, retrieving, etc., data from the backend database 218.

As further illustrated in FIG. 2, the memory 206 includes a reporting module 212 that is responsible for generating administrative reports for organizations that have a waiting list managed by aspects of the present invention. As mentioned previously, data that describes transactions and/or demographics related to a user may be collected and stored in the backend database 218. For any number of reasons, an organization that sells goods or services may want access to this type of data. In accordance with one embodiment, a reporting module 212 is provided that retrieves data maintained in the backend database 212 and provides the data to an organization that has a waiting list managed by aspects of the present invention. In this regard, the reporting module 212 interacts with the database application 218 to retrieve the data that is requested and generates a report. In this regard, a report that contains data useful in maintaining a retail presence online may be generated and transmitted to an organization that has a waiting list managed by aspects of the present invention.

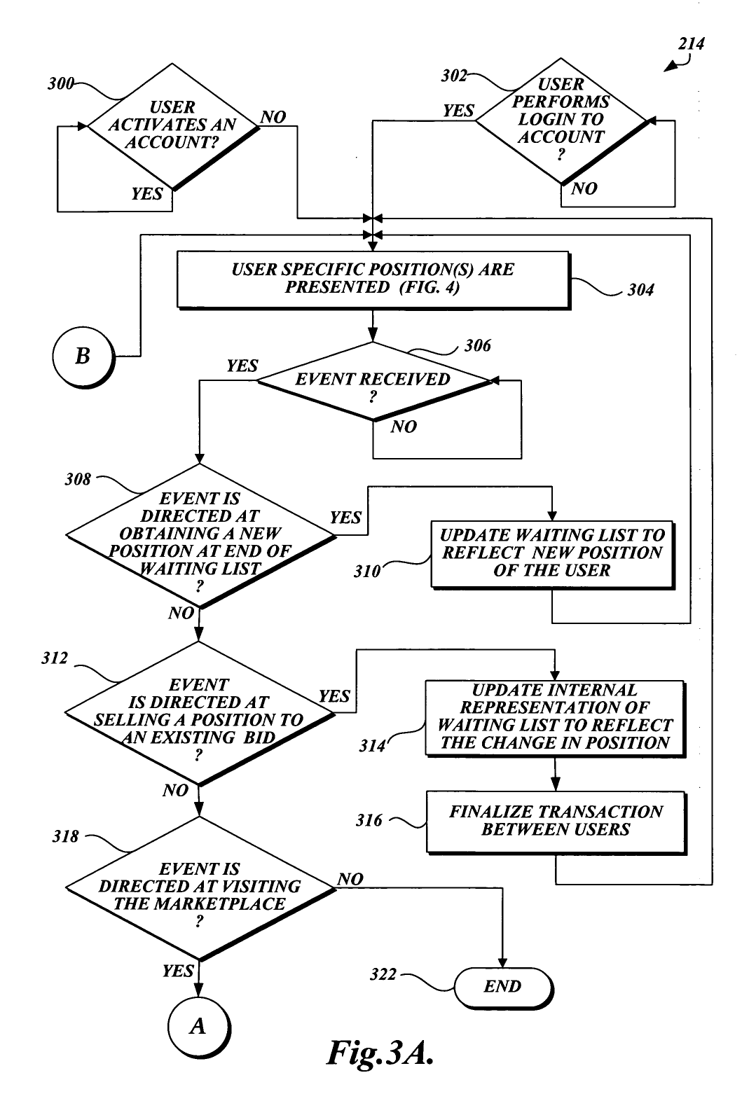

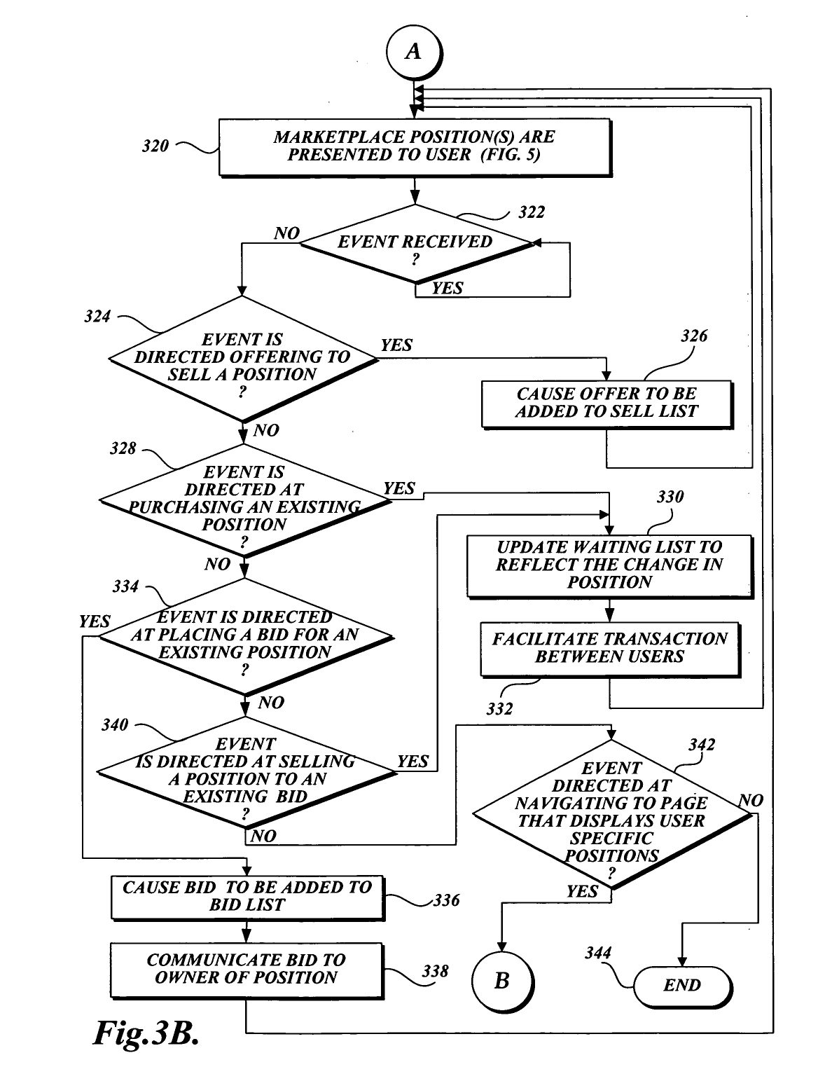

The memory 206 also includes a position exchange routine 214 that implements logic, in accordance with one embodiment of the present invention, that allows a user to exchange (e.g., purchase, sell, trade, etc.) a position in a waiting list with another user. Since aspects of the position exchange routine 214 are described in detail below with reference to FIG. 3A-B, further description of the routine 214 will not be provided here.

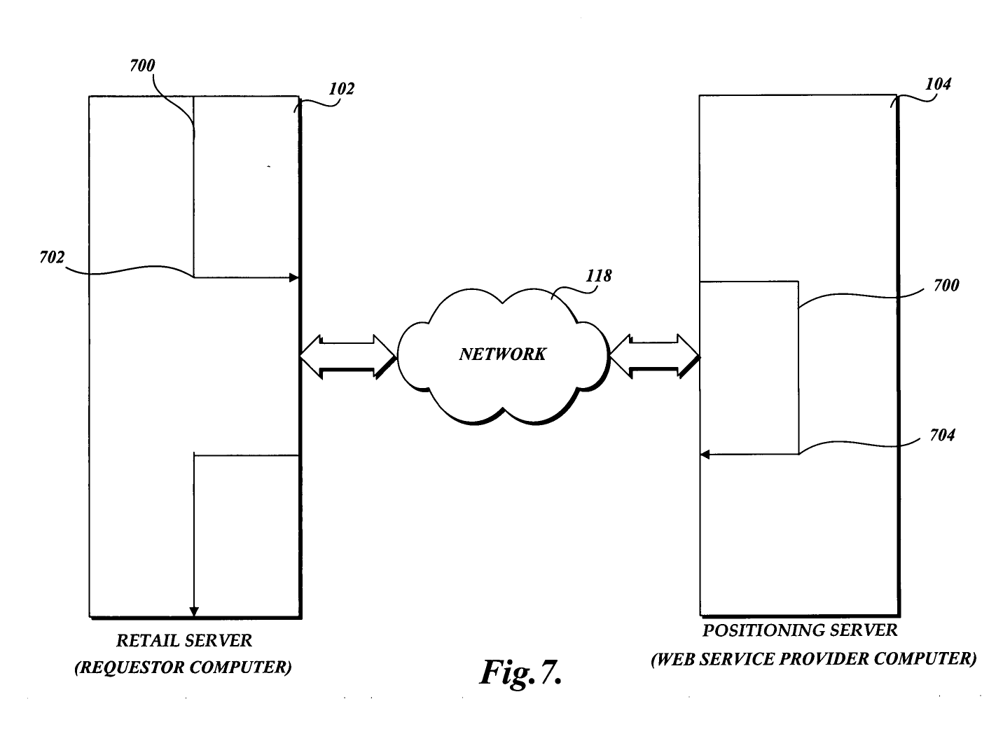

As further illustrated in FIG. 2, the memory 206 also includes a service handler 216 for satisfying service requests received from remote computers. An organization that provides goods and/or services available for purchase on a computer network may have or develop an interface for interacting with users. In this instance, the organization may use the interface to obtain data and otherwise interact with users and still have a waiting list managed on the positioning server 104 by software that implements the present invention. In this regard and in accordance with one embodiment, a service handler 216 is provided that is configured to satisfy service requests for having a waiting list managed by the positioning server 104. However, since the type of functions performed by the service handler 216 are described in detail below with reference to FIG. 7, a detailed description of this aspect of the present invention will not be described in detail here.

As will be appreciated by those skilled in the art and others, FIG. 2 provides a simplified example of one computing system that is suitable for implementing aspects of the present invention. In other embodiments, the functions and features of the computing system shown may be implemented using additional or different components. For example, one or more programs or databases illustrated in FIG. 2, e.g., the Web server 200, the database application 210, the reporting module 212, the position exchange routine 214, or the service handler 216 may execute on a remote computing system. In this instance, information is transmitted over a network, using network protocols for communication between the different systems.

Now with reference to FIGS. 3A and 3B, an exemplary position exchange routine 214 that was mentioned above with reference to FIG. 2 will be described in further detail. Although the routine 214 is described primarily in the context of managing a waiting list to determine priority for tickets to sporting events, the same or similar processes may be employed when a waiting list is used to determine priority in other contexts. In any event, as illustrated in FIG. 3A, the position exchange routine 214 either begins at block 300 or block 302. At block 300, a user activates an account for the purpose of becoming a member of a community of users who have or seek to obtain a position in the same waiting list. In one embodiment, a user activates an account by entering a set of data that describes attributes of the user (e.g., name, address, e-mail address, and the like) into a Web page. However, since obtaining a set of data from a user when the user navigates to a network accessible Web page may be performed using techniques that are generally known in the art, further description of the techniques implemented at block 300 will not be described here. When an account is initially created, validation information (e.g., a username, password, etc.) is communicated to the user so that a login to the account may be performed. In this regard, once the user initially creates an account, the account may be accessed with the username and password. Thus, the position exchange routine 214 may also began at block 302 if a user accesses a Web page for confirming the current user's validation information. It should be well understood that blocks 300 and 302 are optional and not essential for implementing the present invention. Instead, those skilled in the art and others will recognize that access to a community of users may be provided in other contexts without departing from the scope of the claimed subject matter.

At block 304, the position exchange routine 214 causes the user-specific positions in a waiting list to be presented to the current user who performed the account creation or login at block 300 or 302. In one embodiment, the user-specific positions are presented on a Web page such as the Web page 400 described below with reference to FIG. 4.

Now in connection with FIG. 4, an exemplary Web page 400 that is of the type that may be displayed to the user at block 314 (FIG. 3A) and is suitable to illustrate aspects of the present invention will be described. The exemplary Web page 400 depicted in FIG. 4 includes a display area 402 for presenting data and controls to a user that features user-specific positions on a waiting list for season tickets to a particular sports franchise. In this regard, rows 404 and 406 each display information about a position in the waiting list that is owned by the current user. In this example, each row 404 and 406 contains information that describes the order of the position relative to other users, the year the position will be consumed, and the quantity of tickets in the position. Moreover, that data in each row 404 and 406 indicates whether the user previously placed a position for sale in a marketplace and the current asking price and/or bid price for the position.

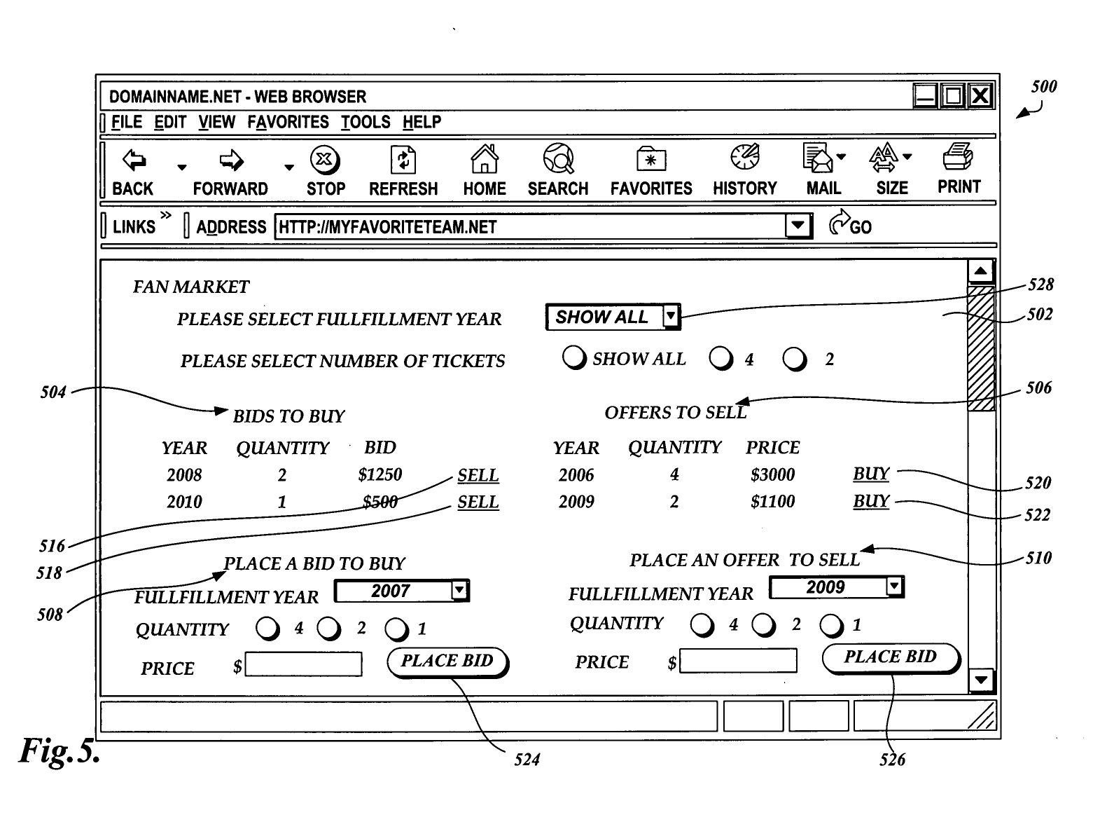

As further illustrated in FIG. 4, the display area 402 also provides embedded controls in the form of the buttons 408, 410, 412 and the link 414. In accordance with one embodiment, when either of the buttons 408 or 410 are activated, the user is given the opportunity to acquire a position in a waiting list for the specified number of tickets. Typically, when a position in a waiting list is initially acquired in this way, the position has the lowest priority relative to other positions that were previously acquired. When the link 414 is activated, an opportunity to accept a bid that was placed for a position owned by the current user by a prospective purchaser is provided. As described in further detail below, a user may offer a position for sale in a marketplace that is accessible to other users. In this instance, an offer to sell a position may receive bids from prospective purchasers; the highest of which is displayed to the user, in the exemplary Web page 400 illustrated in FIG. 4. In this example, by activating the link 414, the current user is provided with the opportunity to accept the current highest bid price obtained from a prospective purchaser. Finally, the button 412 is an embedded control that directs the user to the marketplace in which transactions for positions in a waiting list may be readily exchanged with other users. However, since the information accessible to the user from the marketplace when the button 412 is activated will be described in further detail below with reference to FIG. 5, this aspect of the present invention will not be described here. Those skilled in the art and others will recognize that the exemplary data depicted in FIG. 4, merely provides one embodiment of a Web page 400 that may be presented to the user. In other embodiments, the format and/or data presented to the user may be different without departing from the scope of the claimed subject matter.

Returning now to FIG. 3A, at decision block 306, the position exchange routine 214 remains idle until an event is received that is handled by aspects of the present invention. As described previously with reference to FIG. 4, in one embodiment, a Web page is presented to a user from which different types of events may be generated. For example, the user may activate an embedded control presented on the Web page 400 using a mouse or similar input device. In this regard, those skilled in the art and others will recognize that the embedded controls 408, 410, 412, and 414 described above with reference to FIG. 4 may use conventional mechanisms to direct a user to another network address, e.g., in the form of a Uniform Resource Locator. Moreover, event handlers or other type of program code that implements additional aspects of the present invention receive notice when an event is identified. As described in further detail below, the position exchange routine 214 causes different types of actions to be performed depending on the type of event that is identified at block 306.

As illustrated in FIG. 3A, at decision block 308, a determination is made regarding whether the event identified at block 306 is directed at obtaining a position on a waiting list that has the lowest priority relative to the other positions. As described above with reference to FIG. 4, in one embodiment, a Web page is presented to the user with embedded controls for obtaining a position on a waiting list. For example, the Web page 400 includes buttons 408 and 410 that, when activated, allow a user to be added to a waiting list. In this regard, existing systems notify the position exchange routine 214 when this type of embedded control is activated. In response, the position exchange routine 214 performs the necessary steps to add the user to the waiting list. If the event identified at block 306 is directed at adding a new position to a waiting list, the position exchange routine 214 proceeds to block 310. Conversely, if the event is not directed at adding a position to a waiting list, the routine 214 proceeds to block 312, described in further detail below.

At block 310, the position exchange routine 214 handles the event identified at block 306 by updating the internal representation of the appropriate waiting list to reflect that a new position is being allocated to the current user. If block 310 is reached, a request to obtain a new position on a waiting list was obtained. As mentioned previously, a waiting list may be implemented internally in a computer using any number of different data structures such as, but not limited to, an array, vector, list, queue, etc. Also, those skilled in the art and others will recognize that any number of existing or yet to be develop software systems may be employed to add an entry to an internal representation of a waiting list. In accordance with one embodiment, the internal representation of the waiting list is stored in a database (e.g., the backend database 218) and updated using a database application (e.g., the database application 210). Thus, at block 310, the new position may be added to the waiting list by issuing a call to a database application.

It should be well understood that, among other things, when a new position is added to a waiting last, attributes of the position are stored in an entry in a database. In this regard, each position in a waiting list is associated with a set of data that describes attributes of the position, including, but not limited to, the owner of the position, the order of the position relative to other positions, quantity requested in the position, whether the position is offered for sale, and the like. This type of information may be sorted and otherwise manipulated to satisfy requests and perform other functions implemented by aspects of the present invention. For example, as described above with reference to FIG. 4, information that describes positions owned by a the current user are displayed on a Web page. To generate the Web page, aspects of the present invention cause the-user specific information to be extracted from the appropriate entries in a database using a database application. However, since sorting and extracting information from a database may be performed using systems and techniques that are known in the art, further description of these systems and techniques will not be described here.

In alternative embodiments, in which other types of organizations have a waiting list managed by aspects of the present invention, the attributes associated with a position will typically be different from the attributes described above. In this regard, aspects of the present invention may manage a waiting list that establishes priority between retailers to goods produced by a manufacturer or in other business-to-business contexts. For example, automobile manufacturers use waiting lists to establish priority between dealerships and their customers for vehicles that are scheduled to be built. Obviously, in this example, a position in the waiting list (known in the industry as the “build slot”) will have different attributes than the exemplary attributes described above with reference to FIG. 4. By way of example only, the type of data associated with a position for a “build slot” may include the owner of the position, the order of the position relative to other positions, the model of the vehicle, the year the vehicle is scheduled to be built, and the like. More generally, those skilled in the art will appreciate that the present invention provides a configurable platform capable of managing virtually any type of waiting list, regardless of the good or service that is the object of the waiting list.

Returning to FIG. 3A, at block 312, the position exchange routine 214 determines whether the event identified at block 306 is directed at selling a position to an existing bid. For example, the Web page 400 (FIG. 4) includes the link 414 that, when activated, provides the user with an opportunity to accept a bid price that was made by another user. If the event identified at block 306 is directed at selling a position to an existing bid, the position exchange routine 214 proceeds to block 314. Conversely, if the event is not directed at selling a position to an existing bid, the position exchange routine 214 proceeds to block 318, described in further detail below.

As illustrated in FIG. 3A, at block 314, the internal representation of the waiting list is updated to reflect the sale of the position. As mentioned previously, aspects of the present invention employ a database application to manage the internal representation of a waiting list. Thus, in one embodiment, updating the internal representation of a waiting list, at block 314, is performed through a series of calls issued to a database application. For example, (1) a first call for removing the position currently occupied by the seller, and (2) a second call to insert the purchaser into the a position may be issued to update the internal representation of the waiting list in this instance. However, in other embodiments, those skilled in the art and others will recognize that the internal representation of the waiting list may be updated using different techniques that the example provided here.

At block 316, any actions for finalizing the transaction entered into between the seller and the purchaser to exchange a position in a waiting list is performed. In accordance with one embodiment, a purchaser provides monetary value for a position in the waiting list. In this regard, aspects of the present invention are configured to facilitate the exchange of value from the purchaser to the seller and/or any other organization or entity that has rights to the value. In one embodiment, systems integrated into the list management services provided by aspects of the present invention provides a mechanism for obtaining payment from a purchaser. In an alternative embodiment, a third-party provider that is suitable to handle payment processing may be employed to interact with the purchaser and disperse the value collected.

Finalizing a transaction between a seller and a purchaser may include performing additional types of actions than those described above. For example, when a position for season tickets is sold, the organization that provides the tickets will typically receive information that describes the composition of the waiting list including the owner of the new position so that the tickets may be provided to the appropriate user. As mentioned previously, aspects of the present invention are configured to provide an organization with this type of information. More specifically, the reporting module 212 (FIG. 2) implements routines for communicating this type of data to an organization over a computer network.

In still other embodiments, yet additional types of actions may be performed to finalize a transaction between a seller and a purchaser. By way of example only, aspects of the present invention may perform escrow-type services to ensure that obligations of a seller and purchaser are satisfied in finalizing a transaction. In some instances, the good or service that is the object of a waiting list may be a high-value item. To prevent either party involved in the transaction from committing fraud or other types of malfeasance, the services provided by the present invention may include acting as a neutral third party in accepting performance of the obligations of the seller and purchaser. When performance to the neutral third-party is verified, the appropriate disbursements are completed and the transaction finalized without the purchaser or seller incurring risk of non-performance.

Returning to FIG. 3A, at block 318, the position exchange routine 214 determines whether the event identified at block 306 is directed at visiting a marketplace provided by aspects of the present invention. As described above with reference to FIG. 4, a Web page (e.g., Web page 400) may be displayed that contains user-specific information in reference to a waiting list. Moreover, an embedded control in the form of the button 412 is presented that, when activated, forwards the current user to a marketplace. In any event, if the event identified at block 306 is directed at visiting the marketplace, the position exchange routine 214 proceeds to block 320 (FIG. 3B). Conversely, other types of events may be received at block 306 that are not handled by the present invention. In this instance, existing systems handle the event and the position exchange routine 214 proceeds to block 322, where it terminates.

As illustrated in FIG. 3B, at block 320, the position exchange routine 214 causes a marketplace that aggregates data obtained from multiple users and provides a central location designed to facilitate the exchange of positions in a waiting list is displayed to the current user. In one embodiment, the marketplace is presented on a Web page such as the Web page 500 described below with reference to FIG. 5.

Now with reference to FIG. 5, a specific example of an exemplary Web page 500 that may be displayed to the user at block 320 (FIG. 3B) and is suitable to illustrate aspects of the present invention will be described. The exemplary Web page 500 depicted in FIG. 5 includes a display area 502 for presenting data and embedded controls to a user. Similar to the description provided above with reference to FIG. 4, the display area 502 features information about positions in a waiting list for tickets provided by a sports franchise. However, the Web page 500 depicted in FIG. 5 includes additional mechanisms for facilitating transactions to buy or sell positions in the waiting list. More generally, by activating one or more embedded controls on the Web page 500 the current user may (1) immediately agree to sell a position, (2) immediately agree to purchase an available position from another user, (3) place an offer to purchase a position that is offered for sale, (4) place a bid to sell a position. In this regard, the substantive data contained on the display area 502 is presented principally in four zones 504, 506, 508, and 510 that are entitled “BIDS TO BUY” 504, “OFFER TO SELL” 506, “PLACE A BID TO BUY” 508, and “PLACE AN OFFER TO SELL” 510.

As illustrated in FIG. 5, the “BIDS TO BUY” zone 504 includes two rows of data that each represent a position owned by the current user. As described in further detail below, with mechanisms provided by the present invention, a user may offer to sell a position that is presented to other visitors of the marketplace. In turn, one or more bids to purchase the position may be received with a bid price that is below the asking price. In accordance with one embodiment, the bids to purchase a position from the current user are presented in the “BIDS TO BUY” zone 504. In this regard, the Web page 500 includes embedded controls in the form of links 516 and 518 that, when activated, provide the current user with the opportunity to accept a pending bid.

As illustrated in FIG. 5, the “OFFER TO SELL” 506 zone includes two rows that each represent an offer to sell a position that was previously made by another user. As mentioned above, a user may offer a position for sale that is presented to other visitors of the marketplace. Among other things, the “OFFER TO SELL” 504 zone displays a list of offers to sell a position that were previously made by other user(s). In this regard, the Web page 500 includes embedded controls in the form of links 520 and 522 that, when activated, provide the current user with the opportunity to purchase a position at the current asking price.

The Web page 500 illustrated in FIG. 5 further includes the “PLACE A BID TO BUY” 508 zone and the “PLACE AN OFFER TO SELL” 510 zone. In accordance with one embodiment, the controls presented to the user in the respective zones 508 and 510 provide a way for the current user to input data to (1) either place a position for sale or (2) issue a bid on a position that is currently offered for sale by another user. When the data is entered, and the appropriate embedded control in the form of the buttons 524 or 526 is activated, the data input is collected and stored in a database. In this regard, a bid entered by the current user will be presented in the appropriate zones 504 or 506 when other users visit the marketplace provided by aspects of the present invention.

As further illustrated in FIG. 5, conventional mechanisms for sorting and quickly identifying relevant information are provided on the Web page 500. For example, a user may activate the drop-down menu 528 to have data sorted and presented on an additional Web page based on the fulfillment year of the available positions. Obviously, in this embodiment, the waiting list is segmented into subdivisions in a way that is important to the user and the organization that is providing the good or service. In other embodiments, the waiting list may be segmented and sorted in different ways without departing from the scope of the present invention.

Returning now to FIG. 3B, at decision block 332, the position exchange routine 214 remains idle until an event is received that is handled by aspects of the present invention. Similar to the description provided above with reference to FIG. 4 (at block 306), a user may generate events to input data into the software system provided by the present invention. So, for example, embedded controls presented on the Web page 500 may be activated using a mouse or similar input device. In this instance, an event handler may be notified and executed that handles the event.

At decision block 324, the position exchange routine 214 determines whether the event received at block 322 is directed at offering to sell a position owned by the current user. For example, as described previously from the Web page 500 the owner of a position may enter a set of data that identifies a position and activate an embedded control (e.g., the button 526) for placing an offer to sell the position in a network-accessible marketplace. In any event, if the event identified at block 332 is directed at offering to sell a position that is owned by the current user, the position exchange routine 214 proceeds to block 326. Conversely, if the event is not directed at placing an offer, the routine 214 proceeds to block 328 described in further detail below.

At block 326, the position exchange routine 214 handles the event identified at block 322 by updating the internal representation of a sell list that tracks all of the positions currently being offered for sale. If block 310 is reached, the user generated input directed at offering to sell a position in a marketplace that is accessible to other users. In this instance, a set of data that describes attributes of the position is added to an internal representation of the sell list. Similar to the description provided above, the sell list may be implemented internally as any one of a number of different data structures. In accordance with one embodiment, the internal representation of the sell list is stored in a database (e.g., the backend database 218) and updated using a database application (e.g., the database application 210). Thus, at block 326, the offer received from the user may be added to the sell list by issuing the appropriate call to a database application. Then the position exchange routine 214 proceeds back to block 320.

At decision block 328, the position exchange routine 214 determines whether the event received at block 322 is directed at purchasing a position in a waiting list from another user. As described previously, mechanisms (e.g., links 520 and 522 presented on the Web page 500) are provided that enable a user to accept an offer for purchasing a position on a waiting list from another user. If the event identified at block 322 is not directed at purchasing a position, the position exchange routine 214 proceeds to block 334 described in further detail below. Conversely, if the event identified at block 322 is directed at purchasing a position offered for sale by another user, the routine 214 proceeds to block 330. In one embodiment, at block 330, the internal representation of the waiting list is updated to reflect the purchase of the position entered into by the users. However, since updating the internal representation of the waiting list to reflect the purchase may be performed using the same techniques that were described above with reference to block 314, these techniques will not be described in further detail here. Then, the position exchange routine 214 proceeds to block 332 where actions for finalizing the transaction are performed. However, since a detailed description of the types of actions that may be performed, at block 332, to finalize a transaction are described above (at block 316), further description of this aspect of the present invention will not be provided here. Then the position exchange routine 214 proceeds back to block 320.

At decision block 334, the position exchange routine 214 determines whether the event identified at block 322 is directed at placing a bid to purchase an existing position. As mentioned previously, aspects of the present invention provide a way for users to place a bid on a position that is being offered for sale. For example, the “PLACE A BID TO BUY” zone 508 depicted in FIG. 5 is configured to obtain input that describes attributes of the bid (e.g., price, quantity, and the like) and have a bid issued. If the event identified at block 334 is directed at placing a bid to purchase an existing position, the position exchange routine 214 proceeds to block 336. Conversely, if the event is not directed at placing a bid on a position offered for sale, the routine 214 proceeds to block 340, described in further detail below.

At block 336, the position exchange routine 214 handles the event identified at block 322 by updating the internal representation of a bid list that tracks the pending bids to purchase a position that is being offered for sale. If block 310 is reached, the user generated input directed at placing a bid on a position owned by another user. In this instance, a set of data that describes the bid is added to an internal representation of the bid list that contains all of the pending bids for a particular position. Similar to the description provided above, the internal representation of the bid list is stored in a database (e.g., the backend database 218) and updated using a database application (e.g., the database application 210).

At block 338, the position exchange routine 214 causes the bid issued by the current user to be communicated to the owner of the position. In one embodiment, one or more bids is displayed to the owner of the position on a Web page (e.g., the Web page 400) when an account login is performed. From this type of Web page, the owner of the position may activate an embedded control for the purpose of accepting the bid. In other embodiments, when a new bid is issued, the bid is communicated to the owner of the position using other techniques. For example, in one embodiment, a new bid is immediately communicated to the owner of a position through means of electronic mail. However, in other embodiments, the bid may be communicated using a different technique without departing from the scope of the claimed subject matter. Then the routine 214 proceeds back to block 320.

As further illustrated in FIG. 3B, at block 340, the position exchange routine 214 determines whether the event identified at block 322 is directed at selling a position to an existing bid. As mentioned previously, aspects of the present invention provide a way for an owner of a position to accept an existing bid. For example, the links 516 and 518 depicted in FIG. 5 are embedded controls that may be activated for the purpose of accepting a bid that was previously made by another user. In any event, if the event identified at block 322 is directed at accepting an existing bid, the position exchange routine 214 proceeds back to block 330, described previously. Conversely, if the event identified at block 322 is not directed at accepting an existing bid, the routine 214 proceeds to block 342.

If block 342 is reached, the routine 214 makes a determination whether the event identified at block 322 is directed at navigating to a Web page that displays user specific information such as the Web page 400 described above with reference to FIG. 4. Those skilled in the art and others will recognize that using conventional systems, a user may navigate between Web pages that implement aspects of the present invention. In any event, if the event is directed at navigating to this type of Web page, the position exchange routine 214 proceeds back to block 304 (FIG. 3A). Conversely, other types of events may be received at block 322 that are not handled by aspects of the present invention. In this instance, the event is handled by existing systems and the position exchange routine 214 proceeds to block 344, where it terminates.

The position exchange routine 214 described with reference to FIGS. 3A and 3B is one exemplary embodiment of a method to interact with computer users for the purpose of implementing aspects of the present invention. However, those skilled in the art will appreciate that other methods may be used to interact with users and otherwise provide a marketplace where positions in a waiting list may be exchanged. In this regard, in some instances, steps may be added or removed from the position exchange routine 214. Moreover, in other embodiments, steps may be performed in a different order without departing from the scope of the claimed subject matter. Therefore, the specific implementation of the position exchange routine 214 described with reference to FIGS. 3A and 3B should be construed as exemplary and not limiting.

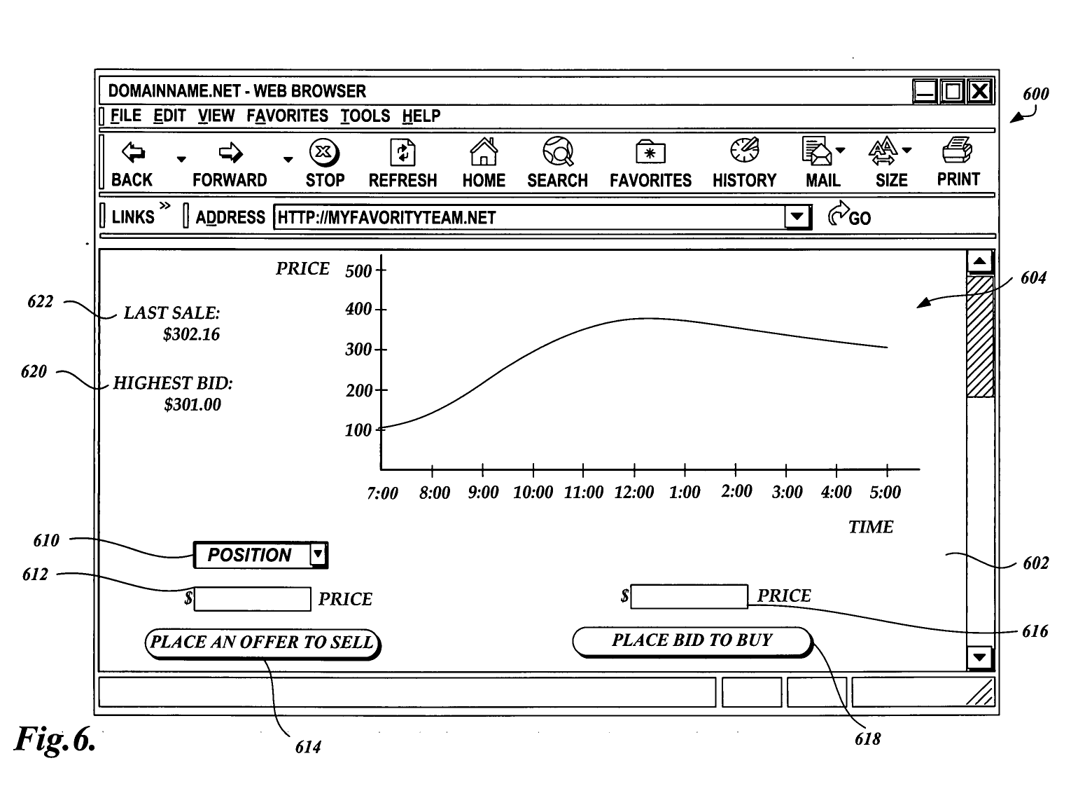

Now with reference to FIG. 6, an additional approach for displaying information to a user in accordance with the present invention will be described. In this regard, FIG. 6 is a specific example of a sample Web page 600 with a display area 602 that presents a two-dimensional graph 604. In this embodiment, the graph 604 plots time on the x-axis and the market price for a given position in a waiting list on the y-axis. Stated differently, the graph 604 provides a user with information regarding the historical price, trends, and current market price for a given position. Moreover, the display area 602 contains embedded controls so that bids to purchase or sell a position may be input into the software system provided by the present invention. For example, to offer a position for sale, a user may interact with the drop-down box 610 to identify the position and enter an asking price into the textbox 612. Moreover, the button 614 may be activated to cause the position to be offered for sale at the stated price. Similarly, in order to purchase a position, an asking price may be entered in the text box 616 and issued when the button 618 is activated. When a seller and prospective purchaser reach an agreement to exchange a position, the graph 604, highest bid price box 620, and/or last sale box 622 are updated to reflect the new market conditions.

It should be well understood that the approach for displaying information depicted in FIG. 6 may complement embodiments of the present invention described above with reference to FIGS. 3-5. For example, embedded controls may be provided on the Web pages 400 (FIG. 4) or 500 (FIG. 5) for navigating to a graph that displays the type of information depicted on the Web page 600. In instances when a large number of transactions are occurring, the format for displaying information on the graph 602 may be especially helpful to both potential sellers and buyers in identifying an appropriate market price and otherwise facilitating the exchange of a given position. Moreover, those skilled in the art and others will recognize that additional embedded controls may be provided on the Web page 600 so that information may be displayed in a different way. For example, embedded controls for viewing the market price of a given position over a different time frame then presented on the graph 602 will typically be provided. Also, additional embedded controls may be provided for the purpose of issuing different types of bids such as market bids, limit orders, and the like.

Now with reference to FIG. 7, another aspect of the present invention will be described in which waiting list management tasks are provided as a service. Those skilled in the art and others will recognize that one system that facilitates the communication of data between network computers, using protocols developed for the Internet, is a Web service. Generally described, a Web service refers to a software system with a network accessible interface that performs actions on behalf of other software systems. A Web service is typically accessed using standard protocols such as the Simple Object Access Protocol (“SOAP”). A software system located on a remote computer may interact with a Web service in a manner prescribed by definitions that are provided in a service description which defines the methods for communicating with the Web service. Also, interactions between software systems typically occur using Extensible Markup Language (“XML”) based messages exchanged via Internet-based protocols, such as the HyperText Transfer Protocol (“HTTP”). In this way, a Web service may expose processes to remote software systems for accessing data or executing operations on a computer, or a cluster of computers, that provides the Web service. Typically, a Web service supports interactions with other software systems at a specified location on a network that may be identified using a URL. A Web service allows developers to use different operating systems and programming languages for communicating between software systems. Moreover, processes provided by a Web service are accessible, for example, by exchanging XML data through a Web interface. As a result, different programs may be combined in a loosely coupled manner to achieve complex operations.

FIG. 7 illustrates a networking environment that depicts the retail server 102 (hereinafter referred to as the “requester computer”) and positioning server 104 (hereinafter referred to as the “Web service provider computer”) that were briefly described above with reference to FIG. 1. In this regard, the requestor computer 102 and the Web service provider computer 104 are communicatively connected via the network 118. As further illustrated in FIG. 7, the requestor computer 102 maintains an exemplary flow 700 of program execution. Prior to the infrastructure of modem networks, programs were executed entirely on a single computer. However, the Web service provider computer 104 maintains a network-accessible Web service with “black-box functionality” that is accessible from a remote computer using standard network protocols. For example, an application executing on one computer, such as the requestor computer 102, may invoke a function on a computer that provides the Web service, at event 702, by issuing a request. As a result, the flow 700 of program execution is transferred from the requestor computer 102 to the Web service provider computer 104. In this instance, invoking the function will typically cause program code to be executed on the Web service provider computer 104. When the function invoked on the Web service completes, at event 704, the flow 700 of program execution is transferred back to the requestor computer 102. Typically, the Web service will cause data in the form of markup code to be transmitted to the requestor computer 102 using standard network protocols.

In accordance with the embodiment described above with reference to FIGS. 1-6, a user interacts with Web pages provided by aspects of the present invention. For example, a full-service software system that both manages a waiting list on behalf of an organization and provides an interface (e.g., a Web site) may be provided. However, in an alternate embodiment, an organization may implement an interface for presenting, obtaining, or otherwise interacting with a user and have waiting list management functions performed using a Web service. By way of example only, the waiting list management functions provided by the present invention in the service handler 216 (FIG. 2) include, but are not limited to, waiting list storage, initiation, trading, selling by auction, reporting, and the like. In response to receiving a Web service request, the Web service provider computer 104 performs the appropriate waiting list management functions in accordance with the description provided above with reference to FIGS. 1-6 and transmits any necessary data back to the requesting computer 102. Those skilled in the art and others will recognize that by providing waiting list management functions as a Web service, aspects of the present invention may be easily integrated with and customized to satisfy the needs of existing e-commerce Web sites and other software systems.

While the preferred embodiment of the invention has been illustrated and described, it will be appreciated that various changes can be made therein without departing from the spirit and scope of the invention.

The embodiments of the invention in which an exclusive property or privilege is claimed are defined as follows:

1. A method performed in a computer networking environment that facilitates the exchange of a position on a waiting list using networked computers, the method comprising:
(a) building a waiting list that establishes priority to a good or service;
(b) providing a network location where a position on the waiting list is presented as being available for exchange; and
(c) in response to an agreement between users to exchange the position on the waiting list, facilitating performance of the agreement.

2. The method as recited in claim 1, further comprising generating a report that includes:
(a) the current composition of the waiting list;
(b) demographic information that describes attributes of users encountered in the networking environment; and
(c) transaction information of agreements entered between users.

3. The method as recited in claim 1, wherein the waiting list maintains subdivisions that define when the good or service will be consumed; and
wherein providing a network location where a position on the waiting list is presented as being available for exchange includes presenting when the good or service will be consumed based on the subdivision in the waiting list where the position is located.

4. The method as recited in claim 1, wherein building a waiting list that establishes priority to a good or service, includes:
(a) providing an input mechanism at the network location for users to be added to the waiting list;
(b) receiving a request at the input mechanism from a user to be added to the waiting list; and
(c) updating an internal representation of the waiting list to reflect that a new position is being allocated to the user that generated the request.

5. The method as recited in claim 4, wherein the input mechanism that enables users to be added to the waiting list is an embedded control presented on a Web page that is available at the network location.

6. The method as recited in claim 1, wherein Web pages are generated at the network location that allow a user to:
(a) issue an offer to sell a position on the waiting list that is presented to other users who visit the network location;
(b) issue an acceptance to purchase a position that was previously offered for sale by another user;
(c) issue a bid to purchase a position that was previously offered for sale at a lower price than the offer; and
(d) issue an acceptance to sell a position that received a lower-priced bid.

7. The method as recited in claim 1, wherein facilitating the performance of the agreement includes causing users to perform their obligations under the agreement to a third-party that completes performance to the appropriate user.

8. A computer-readable medium containing computer-readable instructions that, when executed in a computer that stores a waiting list, performs a method of allowing a first user to obtain a position on the waiting list that is currently owned by a second user, the method comprising:
(a) receiving a sell request from the second user to offer a position on the waiting list as being available for purchase;
(b) publishing terms of the sell request at a location on a computer network;
(c) receiving a buy request from the first user to purchase the position that is available for purchase; and
(d) updating the waiting list to reflect the agreement entered into between the first and second users.

9. The computer-readable medium as recited in claim 8, wherein the method of allowing the first user to obtain a position on the waiting list that is currently owned by the second user is implemented as a Web service.

10. The computer-readable medium as recited in claim 8, wherein receiving a request from a second user to offer a position on the waiting list as being available for purchase, includes:
(a) presenting a Web page to the second user that is contains an embedded control suitable to obtain input regarding terms of the sell request; and
(b) adding the position to a sell list that tracks all of the positions in the waiting list that are available for purchase.

11. The computer-readable medium as recited in claim 8, wherein the location on the computer network where the position is published as being available for purchase is a Web site that includes Web pages configured to obtain input from the first and second user.

12. The computer-readable medium as recited in claim 8, wherein publishing terms of the sell request at a location on a computer network, includes generating a Web page that contains all of the positions on the waiting list that are currently available for purchase from a community of users.

13. The computer-readable medium as recited in claim 8, wherein receiving a buy request from the first user to purchase the position includes receiving a set of data that describes attributes of the buy request when an embedded control on a Web page is activated.

14. The computer-readable medium as recited in claim 8, wherein the buy request received from the first user is an offer to purchase the position at a price that is different than the price submitted in the sell request.

15. The computer-readable medium as recited in claim 14, further comprising:
(a) communicating the buy request to the second user; and
(b) receiving and put from the second user that indicates acceptance of the buy request.

16. The computer-readable medium as recited in claim 8, wherein updating the waiting list to reflect the agreement includes issuing a call to a database application to insert the first user into a position in the internal representation of the waiting list that was previously occupied by the second user.

17. In a computer networking environment that includes a plurality of networked computers, a software system that provides a network location for facilitating the exchange of a position on a waiting list, the software system comprising:
(a) a database for storing data that describes market conditions for positions on the waiting list;
(b) a database application operative to retrieve data from the database when a request is received;
(c) a position exchange routine that provides logic to the Web server program for interacting with users that visit the network location; and
(d) a Web server program operative to:
(i) issue a request to the database application for retrieving data stored in the database; and
(ii) generate Web pages in accordance with the logic provided by the position exchange routine that present market conditions for buying or selling positions on the waiting list.

18. The software system as recited in claim 17, wherein the Web server program is further configured to:
(a) obtain data from a first user that describes a transaction to purchase a position on the waiting list offered for sale by a second user; and
(b) cause the database application to update data stored in the database to reflect the transaction.

19. The software system as recited in claim 17, further comprising a reporting module operative to retrieve data from the database and generate a report that contains:
(a) the current composition of the waiting list;
(b) demographic information of users who visit the network location; and
(c) transaction information of disbursements made when positions on the waiting list are sold.

20. The software system as recited in claim 17, further comprising a service handler operative to accept a Web service request and satisfy the request by:
(a) performing the waiting list management tasks identified in the request; and
(b) transmitting data back to a requesting computer that allows the requesting computer to interact with user regarding the waiting list management tasks that were performed.
